(19) United States
(12) Patent Application Publication
(10) Pub. No.: US 2018/0319245 A1
(43) Pub. Date: Nov. 8, 2018

(54) AUTONOMOUS TRANSPORT COOLING SYSTEM

(71) Applicant: Carrier Corporation, Palm Beach Gardens, FL (US)

(72) Inventors: Robert A. Chopko, Syracuse, NY (US); Ciara Poolman, Syracuse, NY (US); Conner Chen, Manlius, NY (US)

(21) Appl. No.: 15/779,879

(22) PCT Filed: Nov. 30, 2016
(86) PCT No.: PCT/US2016/064062

§ 371 Date: May 30, 2018

Related U.S. Application Data
(60) Provisional application No. 62/261,467, filed on Dec. 1, 2015.

(51) Int. Cl. B60H 1/00; B60H 1/32

(52) U.S. Cl. CPC B60H 1/00264; B60H 1/3222; B60H 1/00014

(57) ABSTRACT

An autonomous cooling unit 310 for a vehicle is provided. The cooling unit includes a housing 316 containing a compressor, a condenser 314, and an evaporator 312, the evaporator configured to cool ambient air. A power module 318 is located within the housing and configured to supply electrical power to each of the compressor, the condenser, and the evaporator. A mounting system 322 is configured to removably mount the housing on a vehicle.

### BACKGROUND

The subject matter disclosed herein generally relates to cooling systems for vehicles and, more particularly, to autonomous cooling systems for vehicles.

Cooling systems in vehicles may be configured with cooling systems, such as refrigeration units, that are set up for providing cooling within a cargo space. Such systems are rigidly connected and attached to the vehicle, such as to a cab or a wall of a cargo space. Further, rigid ducting and/or fabric chutes are used to direct cool air over cargo within the cargo space. In such embodiments, the refrigeration units tend to cool the entire cargo space generally, and do not focus the cooling to a specific area within the cargo space, e.g., they are not configured to cool only the cargo or the space immediately around the cargo.

Further, cooling systems, such as refrigeration units, may be configured with power modules or sources that are attached to or part of vehicles to which they are used. As such, these units may be fixedly attached or connected to a vehicle.

### SUMMARY

According to one embodiment, an autonomous cooling unit for a vehicle is provided. The cooling unit includes a housing containing a compressor, a condenser, and an evaporator, the evaporator configured to cool ambient air. A power module or source is located within the housing and configured to supply electrical power to each of the compressor, the condenser, and the evaporator. A mounting system is configured to removably mount the housing on a vehicle.

In addition to one or more of the features described herein, or as an alternative, further embodiments of the cooling unit may include that the power module is one or more batteries.

In addition to one or more of the features described herein, or as an alternative, further embodiments of the cooling unit may include that the power module is a fuel cell.

In addition to one or more of the features described herein, or as an alternative, further embodiments of the cooling unit may include a flexible duct configured to direct the cooled ambient air to a cargo.

In addition to one or more of the features described herein, or as an alternative, further embodiments of the cooling unit may include that the mounting system comprises keyholes configured to enable mounting of the housing on an interior wall of a vehicle cargo space.

In addition to one or more of the features described herein, or as an alternative, further embodiments of the cooling unit may include that the mounting system is configured to mount to a cab of a vehicle.

In addition to one or more of the features described herein, or as an alternative, further embodiments of the cooling unit may include a base configured to provide support to the housing.

In addition to one or more of the features described herein, or as an alternative, further embodiments of the cooling unit may include that the base is configured to receive a portion of a lifting device.

In addition to one or more of the features described herein, or as an alternative, further embodiments of the cooling unit may include that the power module is rechargeable.

According to another embodiment, a method of manufacturing an autonomous cooling unit for a vehicle is provided. The method includes providing a housing, installing one or more cooling components into the housing, installing a power module in the housing, wherein the power module is configured to supply power to the one or more cooling components, and providing a mounting system with the housing, the mounting system configured to enable mounting of the housing to a vehicle.

In addition to one or more of the features described herein, or as an alternative, further embodiments of the method may include that the power module is one or more batteries.

In addition to one or more of the features described herein, or as an alternative, further embodiments of the method may include that the power module is a fuel cell.

In addition to one or more of the features described herein, or as an alternative, further embodiments of the method may include installing a flexible duct to the housing and configured to direct cooled air from the one or more cooling components to a cargo.

In addition to one or more of the features described herein, or as an alternative, further embodiments of the method may include that the mounting system comprises keyholes configured to enable mounting of the housing on an interior wall of a vehicle cargo space.

In addition to one or more of the features described herein, or as an alternative, further embodiments of the method may include that wherein the mounting system is configured to mount to a cab of a vehicle.

In addition to one or more of the features described herein, or as an alternative, further embodiments of the method may include providing a base configured to support to the housing.

In addition to one or more of the features described herein, or as an alternative, further embodiments of the method may include that the base is configured to receive a portion of a lifting device.

In addition to one or more of the features described herein, or as an alternative, further embodiments of the method may include that the power module is rechargeable.

Technical effects of embodiments of the present disclosure include a cooling unit for a vehicle that is autonomous or self-powered. Further technical effects include a cooling unit having its own power module or power source and mounting system to enable installation on or in any vehicle configuration. Further technical effects include a cooling unit that may be removably attached to and removed from a vehicle.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1 is a schematic illustration of a vehicle without a tarp cover that may employ various embodiments disclosed herein;

FIG. 2 is a schematic illustration of a vehicle cargo space with a tarp cover having a cooling unit in accordance with an embodiment of the present disclosure;

FIG. 3 is a schematic illustration of a cooling unit in accordance with an embodiment of the present disclosure;

FIG. 4 is a side view schematic illustration of a vehicle having multiple cooling units in accordance with embodiments of the present disclosure installed thereon; and

FIG. 5 is a flow process for manufacturing an autonomous cooling unit in accordance with a non-limiting embodiment.

### DETAILED DESCRIPTION

As shown and described herein, various features of the disclosure will be presented. Various embodiments may have the same or similar features and thus the same or similar features may be labeled with the same reference numeral, but preceded by a different first number indicating the figure to which the feature is shown. Thus, for example, element “a” that is shown in FIG. X may be labeled “Xa” and a similar feature in FIG. Z may be labeled “Za.” Although similar reference numbers may be used in a generic sense, various embodiments will be described and various features may include changes, alterations, modifications, etc. as will be appreciated by those of skill in the art, whether explicitly described or otherwise would be appreciated by those of skill in the art.

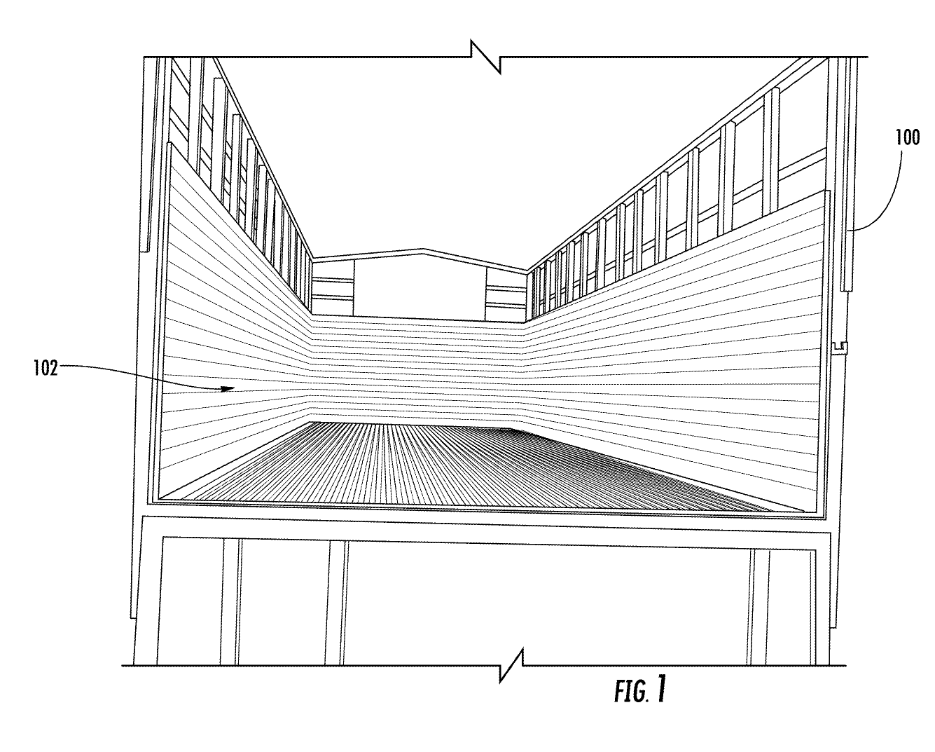

FIG. 1 is a schematic illustration of a vehicle 100 having an open bed or cargo space 102, such as a tarp-covered truck. The vehicle 100 cannot employ a fixed or rigid refrigeration unit because any cooling would be lost due to the open air of the cargo space 102. Even if a cover, such as a tarp, was configured over the cargo space 102, the leakage of any cooling would be sufficient to negate the cooling, or if a fixed or rigid refrigeration unit was employed, the unit may be overworked and fail quickly.

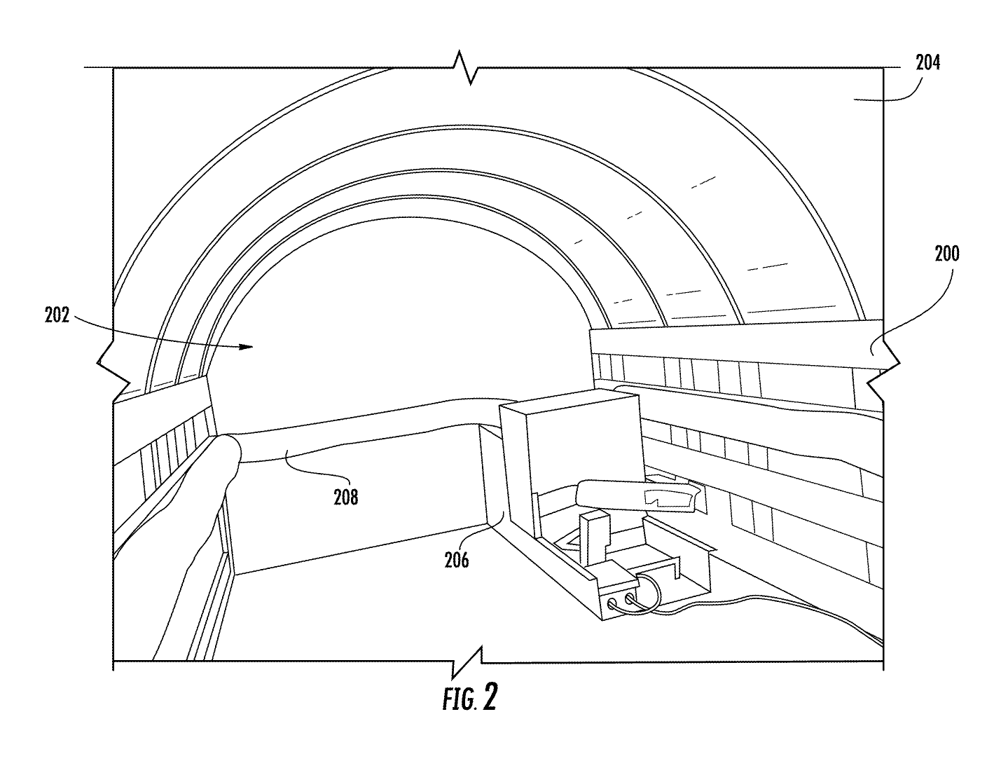

Turning now to FIG. 2, a vehicle 200 may have a cargo space 202, similar to that shown in FIG. 1. In this configuration, the cargo space 202 is covered or enclosed with a cover 204. Located within the cargo space 202 is a cooling system 206. The cooling system 206 may be a refrigeration unit having compressors, heat exchangers, fans, condensers, expansion devices, etc., as known in the art. The cooling system 206 may be configured in a mono-block configuration and connected via refrigerant hoses, not shown, to an open drive compressor powered by the engine of the vehicle 200. In other embodiments, the drive compressor may be powered by an auxiliary engine located on the vehicle 200. Attached to the cooling system 206 may be one or more flexible ducts 208. The flexible ducts 208 may be used to direct cool air to a product or other cargo (not shown) that is located within the cargo space 202.

As shown, rather than being physically connected to the vehicle 200, the cooling system 206 may be configured to sit on a bed of the cargo space 202. In alternative embodiments, described below, the cooling system 206 may be configured to hang or be removably attached to a wall of the cargo space 202 or be located elsewhere on the vehicle 200, such as on top of a cab of the vehicle 200.

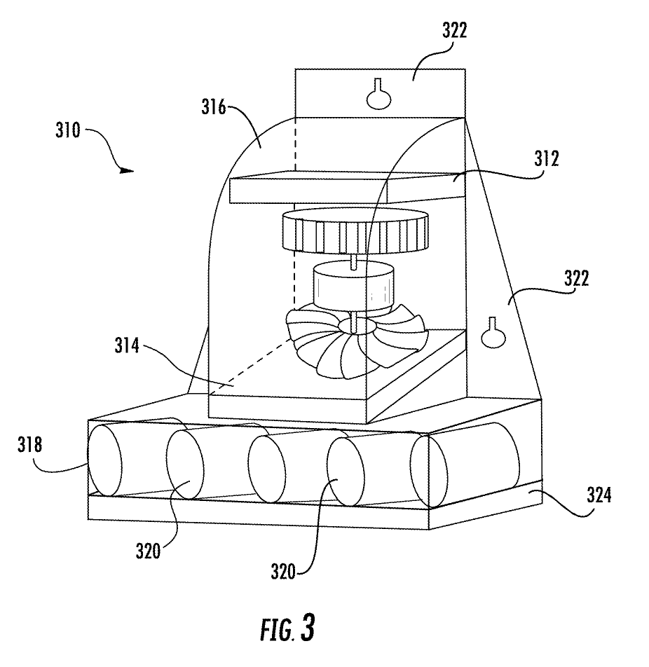

Turning now to FIG. 3, a schematic illustration of a cooling unit 310 in accordance with a non-limiting embodiment of the present disclosure is shown. Cooling unit 310 may be removably attached and installed in or on a vehicle, such as shown in the configuration of FIG. 2.

The cooling unit 310 may be configured as a refrigeration unit having an evaporator 312 and a condenser 314 located within a housing 316. The housing 316 may also house additional components, features, structures, and devices of a refrigeration unit, as known in the art, including, but not limited to, compressors, fans, vents, drive shafts, etc. The evaporator 312 and the condenser 314 may be configured to have the cooling unit 310 intake warm air and condition the air to then exhaust cool or cold air.

The cooling components of the cooling unit 310 may be powered by a power module 318. The power module 318 may be a dedicated power module or power source that supplies power to the electrical components of the cooling unit 310. As shown, the power module 318 may include one or more batteries 320. In some embodiments, the batteries 320 may be rechargeable batteries. Further, in some embodiments, the batteries 320 may be removable and/or replaceable. In some embodiments, the power module may contain one or more fuel cells. Accordingly, the power module 318 may include one or more electrical inlets and/or outlets that may be used for charging the batteries 320 and/or one or more openable panels may be provided to allow access to the batteries 320 within the power module 318.

In some embodiments, the power module 318 may be housed within the housing 316, and in other embodiments, the power module 318 may be housed or contained within a separate housing. The power module 318 is electrically connected to the electrical components of the cooling unit 310 and is configured to supply power exclusively or independently to the cooling unit 310. That is, the power unit 318 is configured to supply sufficient power to the cooling unit 310 to operate the cooling unit 310. As such, no additional power sources are necessary to operate the cooling unit 310 to cool an area, such as an enclosed truck bed.

The cooling unit 310 may be configured as a movable and re-attachable unit that may be installed in or on a vehicle. As such, the cooling unit 310 may include one or more mounting system 322. The mounting system 322 may be sheets of metal with eye-let, key-hole, or other mounting configurations. The mounting system 322 may be configured to mount on hooks, hang from a suspension device, attach to a wall, or otherwise connect and fixedly mount the cooling unit 310 to a portion of a vehicle. In some embodiments, the mounting system 322 may be configured to mount the cooling unit 310 to a cab or other exterior surface of a vehicle.

In some embodiments, as shown in FIG. 3, the cooling unit 310 may include a base 324. The base 324 may be configured to provide support and enable the movability of the cooling unit 310. That is, in some embodiments, the base 310 may be configured to receive the forks of a fork lift or other device such that the cooling unit 310 may be moved, lifted, etc. as needed.

As will be appreciated by those of skill in the art, the above described cooling unit may be scalable in size. Thus, in some embodiments, the cooling unit may be lifted by a single person and mounted within or on a vehicle, and in other embodiments, the use of lifting equipment may be necessary for moving and/or mounting the cooling unit.

In some embodiments, the cooling unit 310 may include quick connections to flexible refrigerant hoses, making it possible to install the cooling unit in multiple locations, e.g., in or on any part of a vehicle. That is, the cooling units described herein may be moveable such that they can be configured with any vehicle configuration, and are thus not dependent on the configuration of the vehicle. For example, in some embodiments, rather than locating the cooling unit within the cargo space of the vehicle, the cooling unit may be connected or installed on a roof of a cab of the vehicle, and a flexible duct or tubing of the cooling unit can deliver cool air to a specific cargo that is in the cargo space of the vehicle.

Further, in some embodiments, multiple cooling units may be employed with the cargo space of the vehicle. Each cooling unit may have flexible ducts to direct cool air to various areas and/or cargo. In some embodiments, the configuration of the cooling unit may be conceived in a clamshell design, using keyholes mountings that may reduce costs of the cooling units. Moreover, in some embodiments, condensate water may be disposed by dripping condensate water directly to the condenser to enhance a cooling capacity of the cooling unit.

In some embodiments, the cargo may be configured within a thermal covering or insulator. In such embodiments, the flexible ducts of the cooling unit may be configured to deliver cool air into a space contained by the thermal covering and use flexible ducts to return the intake warm air of the cargo back to the evaporator, thus supplying maximum cooling to a specific area, even if the vehicle has an open bed for transportation of the cargo.

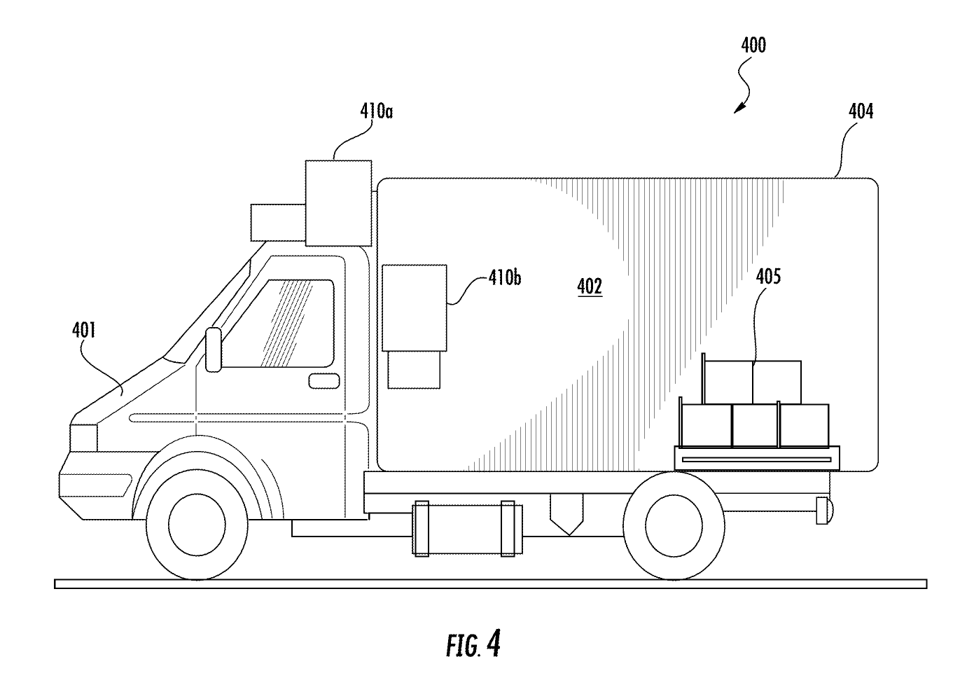

Turning now to FIG. 4, a side view schematic illustration of a vehicle having multiple cooling units in accordance with embodiments of the present disclosure installed thereon is shown. Vehicle 400 includes a cargo space 402 enclosed by a cover 404. The cargo space 402 may be within a bed of the vehicle 400 and may be driven by a cab 401. Within the cargo space 402 may be a cargo 405. The cargo 405 may be a product or other item that may require cooled temperatures and/or air conditioning for maintaining the cargo 405 at desired temperatures. For example, cargo 405 may be a container that includes a perishable item therein or may be crates of produce or other perishable items, and the application of cooled air within the cargo space 402 may prolong the product life of the cargo 405.

As shown, the vehicle 400 may be configured with two cooling units 410a, 410b. As shown, a first cooling unit 410a may be configured external to the cargo space 402. In the example embodiment of FIG. 4, the first cooling unit 410a is installed and mounted to a top of the cab 401. Alternatively, the first cooling unit 410a may be mounted to an exterior surface of the cover 404, such as mounted on panels that provide structure and walls to the cargo space 402. A second cooling unit 410b is shown mounted on an interior wall of the cargo space 402. The second cooling unit 410b may be positioned on a floor of the cargo space 402, depending on the desired configuration and the vehicle. As will be appreciated by those of skill in the art, a vehicle may be configured with any number of cooling units 410 to provide a desired cooling within a cargo space or other area.

Further, because the cooling units 410a, 410b are autonomous, as described above, the cooling units 410a, 410b may be removed from the vehicle 400 and installed in another vehicle (not shown). The cooling units 410a, 410b may also be removed for the purpose of charging the power module of each of the units, such as by connecting the power modules of the cooling units to a grid power, solar panels, etc.

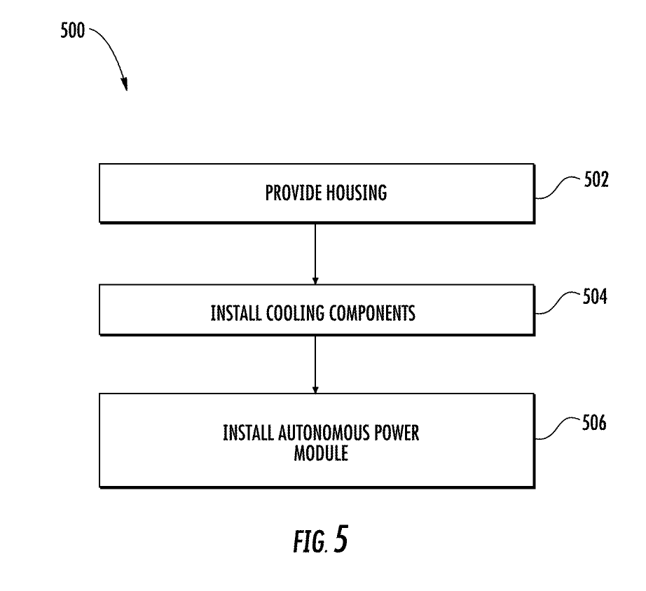

Turning now to FIG. 5, a flow process for manufacturing an autonomous cooling unit in accordance with a non-limiting embodiment is shown. Flow process 500 may be used to manufacture a cooling unit similar to that shown in FIG. 3. Thus, at block 502, a housing may be provided for housing components of a cooling unit. The housing may include a mounting system, or a mounting system may be installed on the housing. At block 504, the cooling unit components may be installed into the housing. For example, an evaporator, a condenser, a compressor and other cooling components may be installed in the housing, including but not limited to, fans, vents, drive shafts, etc. Additionally, at block 506, an autonomous or independent power module may be installed in or on the housing. The installation of the power module may include electrically connecting the power module to one or more components of the cooling unit. Thus, a moveable, autonomous cooling unit may be manufactured.

Advantageously, embodiments described herein provide a cooling unit for cargo that may be employed in a vehicle having a generally open cargo space, such as vehicles having cargo spaces that are covered by tarps. For example, advantageously, fresh food may be transported in any type of vehicle without requiring a specialized vehicle. Advantageously, a relatively inexpensive cooling system is provided that is able to reduce temperature and humidity of a cargo space or specific cargo. In this way an inexpensive solution can be used, capable of extending cargo life compared to a situation where no cooling is used at all. Furthermore, advantageously, cooling units as described herein can be easy and very flexible with regards to installation, adapting to open trucks and multiple configurations.

Advantageously, embodiments disclosed herein offer a low cost alternative to the “normal” food transportation in developing countries (no refrigeration). Also, embodiments disclosed herein offer a flexible installation solution, adaptable to multiple vehicle configurations. Further, embodiments disclosed herein enable the possibility of a power-pack module, offering the possibility to cool a cargo even in cases when the vehicle engine does not have sufficient residual power.

Advantageously, embodiments described herein provide a cooling unit equipped with an independent power source or module and a modular mounting system. As such, the cooling unit may be mounted to and dismounted from vehicles on an as-needed basis. Advantageously, in developing economies, embodiments described herein enable any available truck to be employed for transporting perishable items when the described cooling units are mounted in or on the vehicle.

Further, advantageously, embodiments described herein eliminate the need to mount a compressor to an engine of a vehicle as the compressor is independently powered by the attached power module of the cooling unit. As such, a consistent cooling power may be provided that is independent of the vehicle. For example, the cooling power may be independent of an engine speed. Further, because the cooling unit includes a dedicated or autonomous power module, and may be configured as batteries, fuel cells, or other moveable power module, the total power output may be configured and catered to a particular use or situation. For example, the total power may be increased by increasing the number or type of battery, and thus the amount of cooling, whether in duration or in temperature, may be controlled, in part, by controlling the configuration of the power module of the cooling unit.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions, combinations, sub-combinations, or equivalent arrangements not heretofore described, but which are commensurate with the spirit and scope of the present disclosure. Additionally, while various embodiments of the present disclosure have been described, it is to be understood that aspects of the present disclosure may include only some of the described embodiments.

For example, although described herein with respect to trucks, those of skill in the art will appreciate that cooling units as described herein may be employed in other vehicles, such as boats and/or aircraft. Moreover, the cooling units described herein may be able to be completely removed from a vehicle, such that cooling may be provided to a cargo that is removed from the vehicle. That is, the cooling unit may be removed from the vehicle and may be moved with a cargo to continuously provide cooling to the cargo.

Further, for example, although one relative size is shown in the accompanying drawings, those of skill in the art will appreciate that cooling units described herein may be scalable, such that a small, autonomous unit may be made without departing from the scope of the disclosure. Thus, the drawings are merely provided for illustrative and explanatory purposes and are not intended to be limiting.

Accordingly, the present disclosure is not to be seen as limited by the foregoing description, but is only limited by the scope of the appended claims.

1. An autonomous cooling unit for a vehicle, the cooling unit comprising:
a housing containing a compressor, a condenser, and an evaporator, the evaporator configured to cool ambient air;
a power module located within the housing and configured to supply electrical power to each of the compressor, the condenser, and the evaporator; and
a mounting system configured to removably mount the housing on a vehicle.

2. The autonomous cooling unit of claim 1, wherein the power module is one or more batteries.

3. The autonomous cooling unit of claim 1, wherein the power module is a fuel cell.

4. The autonomous cooling unit of claim 1, further comprising a flexible duct configured to direct the cooled ambient air to a cargo.

5. The autonomous cooling unit of claim 1, wherein the mounting system comprises keyholes configured to enable mounting of the housing on an interior wall of a vehicle cargo space.

6. The autonomous cooling unit of claim 1, wherein the mounting system is configured to mount to a cab of a vehicle.

7. The autonomous cooling unit of claim 1, further comprising a base configured to provide support to the housing.

8. The autonomous cooling unit of claim 7, wherein the base is configured to receive a portion of a lifting device.

9. The autonomous cooling unit of claim 1, wherein the power module is rechargeable.

10. A method of manufacturing an autonomous cooling unit for a vehicle, the method comprising:
providing a housing;
installing one or more cooling components into the housing;
installing a power module in the housing, wherein the power module is configured to supply power to the one or more cooling components; and
providing a mounting system with the housing, the mounting system configured to enable mounting of the housing to a vehicle.

11. The method of claim 10, wherein the power module is one or more batteries.

12. The method of claim 10, wherein the power module is a fuel cell.

13. The method of claim 10, further comprising installing a flexible duct to the housing and configured to direct cooled air from the one or more cooling components to a cargo.

14. The method of claim 10, wherein the mounting system comprises keyholes configured to enable mounting of the housing on an interior wall of a vehicle cargo space.

15. The method of claim 10, wherein the mounting system is configured to mount to a cab of a vehicle.

16. The method of claim 10, further comprising providing a base configured to support to the housing.

17. The method of claim 10, wherein the base is configured to receive a portion of a lifting device.

18. The method of claim 10, wherein the power module is rechargeable.
